(19) United States
(12) Patent Application Publication
(10) Pub. No.: US 2025/0029179 A1
(43) Pub. Date: Jan. 23, 2025

(54) Method and System for Financing Global Energy Assets through Diverse Financial Instruments on a Digital Marketplace

(71) Applicants: Deepak Kumar Rauniar, KATHMANDU (NP); Neeru Sharma, Cooksville, MD (US)

(72) Inventors: Deepak Kumar Rauniar, KATHMANDU (NP); Neeru Sharma, Cooksville, MD (US)

(21) Appl. No.: 18/353,411

(22) Filed: Jul. 17, 2023

(51) Int. Cl. G06Q 40/04; G06Q 30/018; G06Q 40/06

(52) U.S. Cl. CPC G06Q 40/04; G06Q 30/018; G06Q 40/06

(57) ABSTRACT

The Energy Asset Financing marketplace is an innovative digital platform designed to bridge the investment gap in global energy funding and promote clean energy. The marketplace connects global investors and asset owners offering customized financial instruments and increasing access to finance. It utilizes advanced technologies like blockchain, AI, and data analytics to ensure innovation, seamless operations, and personalized user experiences. Asset owners submit funding proposals. The marketplace prioritizes financially viable assets through rigorous evaluation processes promoting sound investment opportunities. Investors can explore various investment opportunities and actively participate in financing energy assets aligned with their objectives. The platform offers a user-friendly interface, comprehensive information on financial instruments and energy assets, and supports secure transactions and multiple currencies. Tokenization technology allows for fractional ownership and trading of energy assets. Tokens also serve as a reward for sustainable practices. To summarize, the marketplace revolutionizes energy asset financing fostering a sustainable investment ecosystem.

### BACKGROUND OF THE INVENTION

The present invention relates to system and method for a computer-based marketplace of diverse financial instruments facilitating global energy asset financing by connecting global investors and energy asset owners needing funding to develop their assets and enabling funding through diverse financial instruments (FIs) that can be purchased, traded or redeemed in the marketplace that increases access to finance.

The global energy landscape is currently faced with the challenge of meeting energy security, clean energy, and Net Zero goals in the face of climate change and sustainable development. However, the existing financing mechanisms and traditional sources of investment have proven insufficient to bridge the significant investment gap required for global energy projects. Moreover, the lack of inclusive and accessible platforms for private sector investment has further impeded the advancement of clean energy initiatives worldwide. Therefore, there is a pressing need for an innovative marketplace that serves as a central hub for global investors and energy asset owners, offering a diverse range of customized FIs to address the unique financing requirements of energy projects and investors. The energy asset funding marketplace facilitates the matching of investors and asset owners based on specific preferences and risk profiles, while enabling investment through the seamless purchase and trade of FIs, ultimately facilitating the financing of global energy assets.

### BRIEF SUMMARY OF THE INVENTION

The present invention introduces the world's first Energy Asset Financing (EAF) marketplace of diverse financial instruments specifically designed to finance global energy assets. By providing finance for clean and renewable energy assets under renewable power generation, energy storage, electric vehicles (EVs) and transportation, energy efficiency, clean fuels green building and construction, and carbon capture and utilization, this marketplace (energy asset owners, investors, buyers, consultants, FIs etc.) further accelerates the development of clean energy and the transition to a Net Zero (NetZ) economy.

The EAF marketplace provides a platform for investors, project developers, and other stakeholders to access a wide array of financial instruments that are customized to meet the unique requirements of energy assets. The financial instruments that are offered include but are not limited to bonds, green bonds, green loans, green funds, carbon offset finance, peer-to-peer lending, futures, structured finance products, project finance arrangements, digital assets, tokens, and other innovative financial tools. By providing a comprehensive range of financial instruments, including new forms of value representation, the marketplace furthers opportunities and avenues for raising finance and promoting investment. By bringing together global investors, asset owners, project developers, and other stakeholders, it provides increased access to finance to drive substantial investments in energy assets.

The EAF marketplace utilizes a secure and scalable digital platform that provides a user-friendly interface, robust risk assessment mechanisms, and secure transactional infrastructure, fostering seamless operations, an innovative user experience, and trust among participants. With the integration of advanced technologies like cloud and mobile technologies, blockchain, smart contracts, machine learning, artificial intelligence, data analytics, and stringent data security measures, the platform enhances accessibility, functionality, reliability, intelligent insights, personalized user experiences, real-time monitoring, and secure transactions.

The EAF marketplace maximizes its operations and accessibility through cloud technologies, providing scalable infrastructure, storage, and computing power for users to access services anywhere, anytime. It leverages blockchain for tokenizing energy assets and ensuring secure and immutable financial transactions. Smart contracts automate and enforce agreements, streamlining payments and settlements. Machine learning and AI algorithms learn user behavior, preferences, and investment needs and patterns, enabling personalized recommendations, risk assessments, and predictive analytics. Robust security measures safeguard sensitive data, ensuring privacy, secure access controls, and compliance with data protection regulations.

The EAF marketplace caters to investors and project developers, allowing them to register, create profiles, and conduct transactions, with access granted exclusively to users who successfully adhere to the Know Your Customer (KYC) guidelines. Additionally, investor eligibility is recorded and monitored based on their geographic origin to align with the relevant policies of that geography. Only eligible investors are allowed to make investments.

There exists a good set of investors, who remain attracted to invest in clean and renewable energy out of environmental considerations, supportive policies, incentives, economic viability, market opportunities, long-term stability, social impact, and ESG integration. These investments help them in portfolio diversification, contribute to a sustainable future, and take advantage of the market opportunities for attractive financial returns. The EAF marketplace offers investors the chance to explore a diverse array of investment opportunities, assess associated risks and returns, and actively participate in financing energy projects that align with their investment objectives and preferences, and risk appetite. Investors can purchase FIs using fiat currency, Central Bank Digital Currencies (CBDC), or cryptocurrencies, ensuring flexibility and accessibility.

Project developers can utilize the EAF marketplace as a platform to submit their funding needs and investment proposals. With robust risk assessment models and rigorous due diligence processes in place, the marketplace evaluates the feasibility and creditworthiness of energy developers seeking financing. Only financially viable projects are selectively featured, ensuring that only those with strong economic prospects are included. This careful evaluation process aims to promote sound investment opportunities while mitigating the risk of supporting financially unsustainable projects. By upholding this approach, the marketplace maintains its integrity and provides investors with a curated selection of energy assets that offer the potential for favorable returns. Prioritizing financial viability fosters a sustainable investment ecosystem, contributing to the overall economic growth and success of the listed projects.

The EAF marketplace offers a user-friendly interface that allows participants to search, compare, and select various information pertaining to energy assets, investors, developers, financial instruments, tokens, offerings, and trade. The platform provides comprehensive information about each financial instrument, including details on terms, returns, risk profiles, and sustainability metrics. The platform incorporates advanced data analytics and machine learning algorithms to provide personalized investment recommendations, risk assessment models, and predictive analytics for optimized decision-making based on investment preferences and risk appetite. Furthermore, the marketplace enables ongoing monitoring and reporting of the performance and impact of the financed energy assets. Participants can access real-time data on project performance, energy generation, emission reductions, and financial returns. This information allows investors to make informed decisions and track the progress of their investments.

To facilitate seamless transactions, the EAF marketplace incorporates secure payment gateways and supports multiple currencies, including fiat currencies, CBDC, and cryptocurrencies. The platform ensures compliance with relevant regulations and standards, including anti-money laundering (AML) and know-your-customer (KYC) requirements.

By utilizing tokenization technology on the blockchain, the EAF marketplace enables representing and dividing energy assets such as power plants or renewable energy projects into smaller, tradable units as digital tokens, facilitating fractional ownership of energy assets and enhancing investment opportunities for a broad range of investors. Furthermore, investors can take advantage of token trading capabilities in the marketplace, allowing them to buy, sell, and exchange these tokens at their convenience and generate returns. To incentivize participation and promote sustainable practices, token holders can be rewarded with additional tokens based on predetermined criteria, encouraging ongoing engagement and fostering a vibrant marketplace ecosystem. The native token is a store of value in energy terms, having an equivalent monetary representation as per some defined standards. It can be rewarded or purchased or traded on the EAF marketplace platform or in a peer-to-peer or intermediary-assisted manner opening new means of financing.

As a use case example, let's consider a hotel that wants to transition from using a backup diesel generator to solar power. The hotel registers on the innovative marketplace described in this patent, indicating their funding requirement of $4 million for the solar power installation and submits the necessary documentation. The EAF marketplace employs advanced back-office operations, risk assessment models, and due diligence processes to evaluate the hotel's creditworthiness and assess the feasibility of the project.

After conducting a comprehensive assessment of the investment proposal, prevailing market conditions, and the hotel's cash flows, the marketplace determines that debt financing is suitable for the hotel. The recommended financing option includes an interest rate of 5% and a tenure of 4 years. Based on this evaluation, the EAF marketplace suggests the creation of 40,000 digital financial instruments, each with a value of $100. These digital instruments, akin to promissory notes, are created as digital assets utilizing blockchain technology and are listed for sale on the marketplace.

The EAF marketplace selectively presents these financial instruments to relevant investors who can purchase them, thereby providing the necessary funding to the hotel for its solar power project. Investors consider various factors, such as the potential financial returns, portfolio diversification, engagement in clean energy initiatives, tax incentives, policy compliance, and environmental, social, and governance (ESG) considerations when deciding to purchase these financial instruments.

The purchase of the financial instruments is recorded securely on the blockchain, ensuring the transparency and immutability of ownership and transaction details. The EAF marketplace utilizes machine learning and AI algorithms to continuously learn and adapt during the process, enhancing its capabilities and efficiency over time.

Repayments for the financial instruments are automated through an escrow account maintained with a banking partner that possesses the necessary system capabilities. This ensures seamless and timely repayment processes for investors. Additionally, the EAF marketplace allows investors the flexibility to purchase these financial instruments using traditional fiat currency or digital currencies such as central bank digital currencies (CBDCs) or cryptocurrencies, expanding the options for investment in global clean energy projects.

Through this use case, the EAF marketplace successfully attracts private sector investment from global investors, offering a diverse range of asset choices and investment opportunities while mitigating risks through smaller investment ticket sizes and a wide range of options. The inclusion of digital payment systems for instrument purchases and repayments streamlines and enhances convenience for investors, further strengthening the overall efficiency and accessibility of the marketplace.

As another use case, let's consider a solar company seeking to raise $5 million in equity to develop a commercial solar plant. The marketplace's tokenization technology is leveraged to tokenize the investment, creating 50,000 tokens priced at $100 each. These tokens represent fractional ownership of the solar plant and can be freely bought, sold, and traded within the marketplace. Tokenization allows for the fragmentation of ownership rights and value into smaller, tradable portions, opening up opportunities for a wider range of investors, including small investors, to participate in the project. The marketplace's low entry barrier enables greater accessibility and inclusivity. The tokenization process not only facilitates the seamless trading of ownership rights but also enhances liquidity, transparency, and efficiency within the asset transaction. It fundamentally transforms the financing, trading, and management of the solar plant, enabling investors to engage with fractions of the asset and benefit from the potential financial returns associated with its operation.

As another use case, let's consider the establishment of a green fund valued at $5 million by a fund manager on the marketplace, dedicated to investing in promising clean energy projects worldwide. The fund is divided into 50,000 financial instruments, each priced at $100, and designed with specific payout conditions. These instruments are generated and maintained as digital assets on the blockchain, ensuring transparent ownership and immutable financial transactions. Global investors have the opportunity to purchase and sell these instruments, with all transactions recorded securely on the blockchain, providing transparency and enhancing trust in the marketplace. Beyond financial returns, investors can acquire these instruments to diversify their portfolios, support clean energy initiatives, capitalize on tax incentives, comply with policies, or engage in socially responsible investing, including ESG and carbon offset initiatives. This approach fosters liquidity among global investors, enabling capital to flow into clean energy projects around the world. The marketplace facilitates the seamless interaction between fund managers, asset owners, and investors, bridging the gap between investment opportunities and the financing needs of clean energy projects, thus accelerating the transition to a sustainable and low-carbon future.

Further aspects of the invention will become apparent from consideration of the drawings and the ensuing description of preferred embodiments of the invention.

### BRIEF DESCRIPTION OF DRAWINGS

A more complete understanding of the present inventions may be derived by referring to the detailed description and claims when considered in connection with the Figures, wherein like reference numbers refer to similar elements throughout the Figures, and:

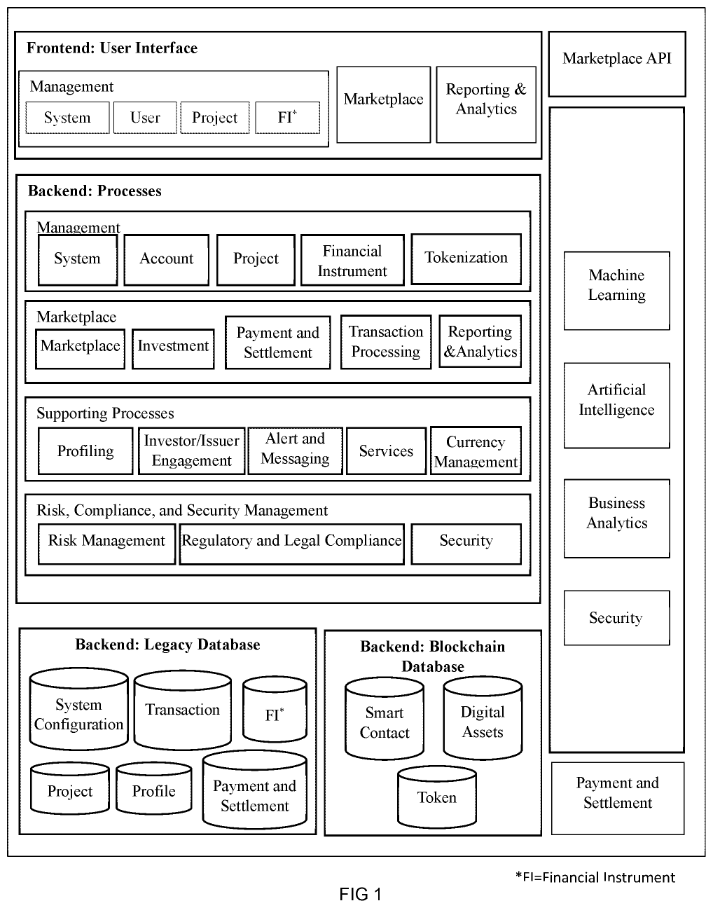

a. FIG. 1 is a block diagram illustrating a high-level conceptual design for enabling digital marketplace for global energy asset funding, in accordance with an exemplary embodiment of the present invention.

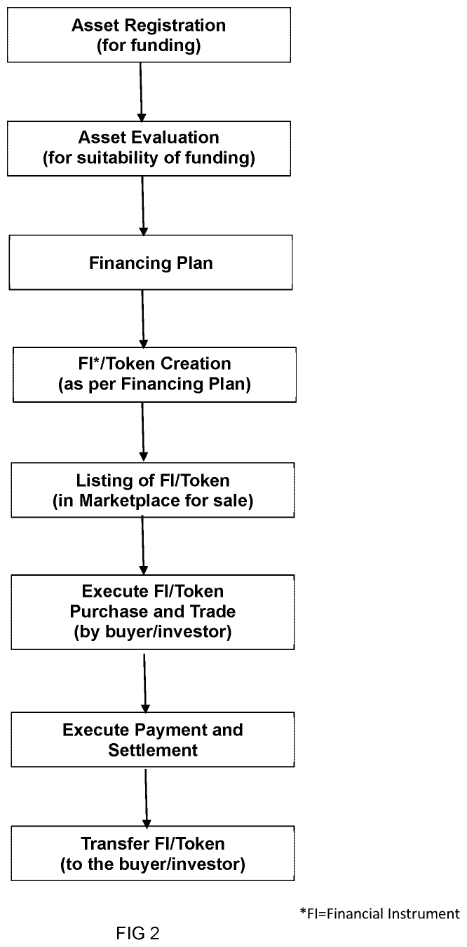

b. FIG. 2 is a flow chart illustrating an exemplary process for funding an energy asset through Financial Instruments/Tokens, in accordance with an exemplary embodiment of the present invention.

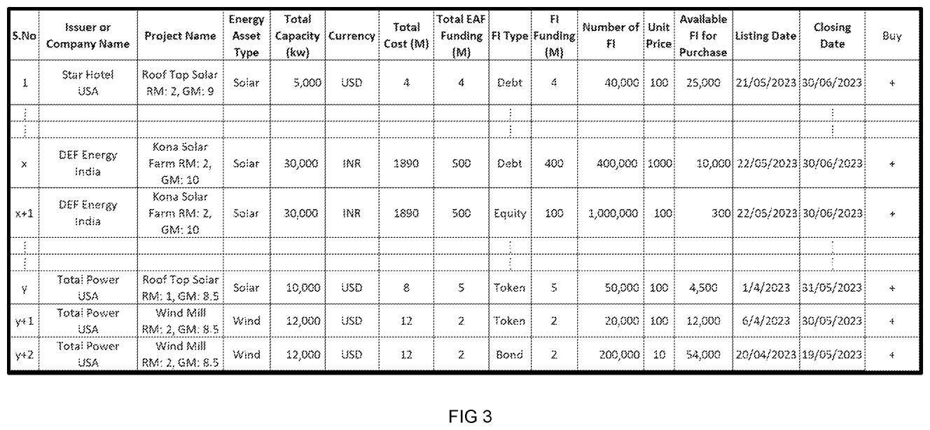

c. FIG. 3 is a schematic representation of the relational type Listing Database maintained for listing FIs for sale, in accordance with an exemplary embodiment of the present invention.

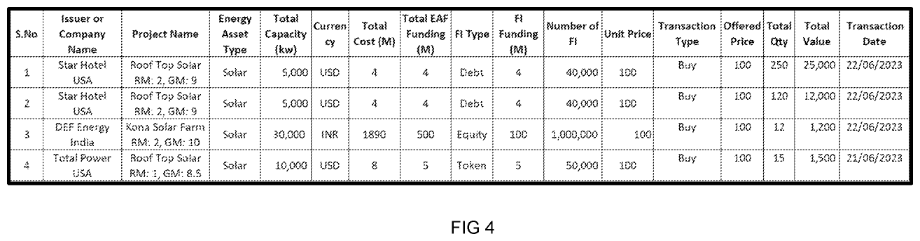

d. FIG. 4 is a schematic representation of the relational type of Database maintained for listing FIs for sale, in accordance with an exemplary embodiment of the present invention;

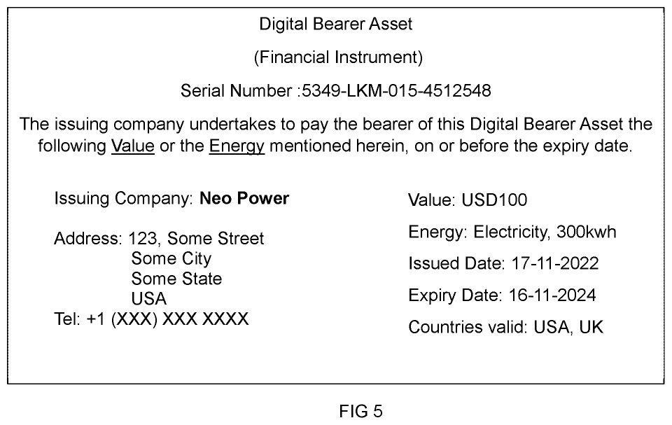

e. FIG. 5 is a schematic representation of a Financial Instrument for funding an energy asset for financial benefits or to be redeemed for energy mentioned therein, in accordance with an exemplary embodiment of the present invention.

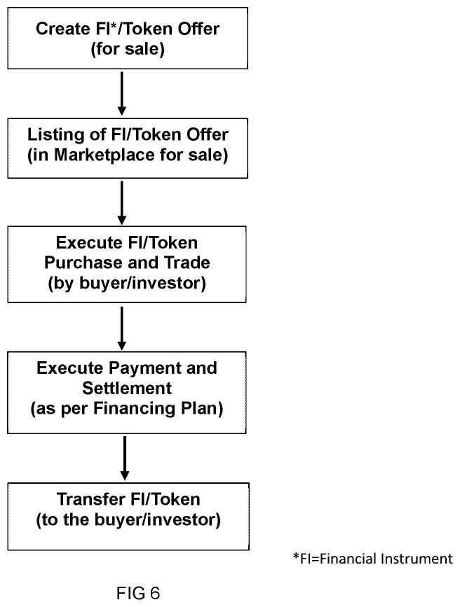

f. FIG. 6 is a flow chart illustrating an exemplary process for trading of Financial Instruments or Tokens, in accordance with an exemplary embodiment of the present invention.

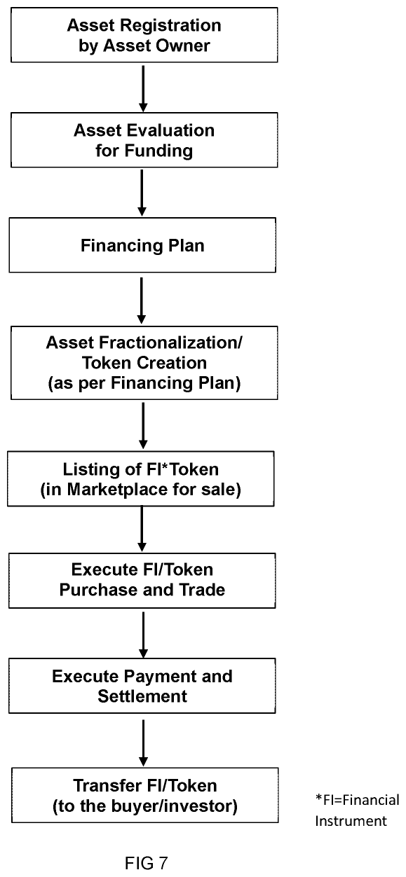

g. FIG. 7 is a flow chart illustrating an exemplary process for the Tokenization of Energy Asset for funding and Fractional Ownership of the Energy Assets through Token, in accordance with an exemplary embodiment of the present invention.

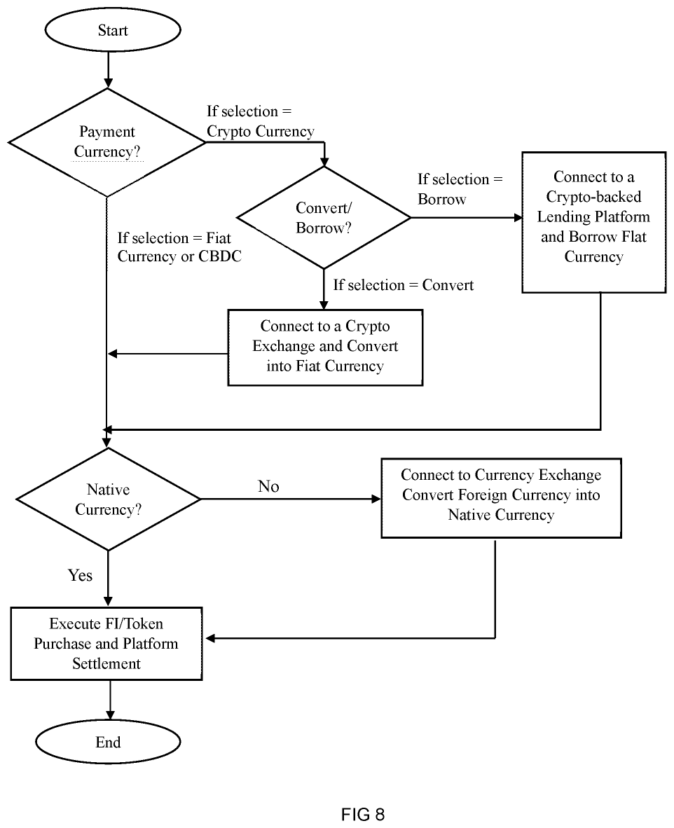

h. FIG. 8 is a flow chart illustrating an exemplary process for the purchase of a Financial Instrument or Token using Fiat Currency, Central Bank Digital Currency, or Cryptocurrency, in accordance with an exemplary embodiment of the present invention.

### DETAILED DESCRIPTION OF THE INVENTION

One embodiment of the systems and methods of a digital marketplace for global energy asset funding involves a sophisticated platform that connects energy asset holders seeking funding with global investors looking to invest in diverse financial instruments. In various embodiments, the described system introduces a transformative marketplace that connects interested investors with energy asset developers, facilitating the funding and development of energy projects through efficient financial transactions. The system operates as a web-based platform, streamlining the marketing and sales process of financial instruments. By consolidating the creation of these instruments, the transaction platform enhances efficiency and standardization, simplifying the process of bringing financial instruments to market. As a result, the system becomes a comprehensive resource for global investors, offering not only a marketplace for energy financing but also centralized access to a diverse range of global energy assets. In addition to facilitating deal negotiation and execution, the system provides search and referral services, ensuring investors have a seamless experience in finding suitable investment opportunities. The EAF marketplace leverages blockchain technology to facilitate the issuance, trading, and management of tokens as a new means of financing and representing ownership or investment rights in energy assets.

The EAF marketplace offers numerous exemplary benefits that significantly impact the energy sector. It provides enhanced access to capital, enabling energy projects of all sizes to secure funding from a wide range of investors. The EAF marketplace offers a diverse range of financing options tailored to the specific needs of energy projects, promoting flexibility and suitability. By streamlining transaction processes, the EAF marketplace ensures efficiency and transparency, utilizing technologies like smart contracts and blockchain. It facilitates market liquidity and secondary trading, enhancing investment attractiveness and capital flow. The EAF marketplace incorporates risk mitigation mechanisms and investor protection measures, fostering a trustworthy investment environment. It promotes innovation and technological advancements, aligns with sustainable and ESG goals, and encourages knowledge sharing and collaboration among industry professionals. Overall, these benefits contribute to the growth, efficiency, and sustainability of the energy sector.

While the disclosed embodiments provide sufficient detail to enable those skilled in the art to implement the invention, it should be understood that alternative embodiments can be realized, and logical and mechanical modifications can be made without departing from the essence and scope of the invention. Therefore, the detailed description provided here serves as an illustration and not as a limitation.

For the sake of conciseness, conventional aspects of the database including blockchain database, application development, and other functional elements of the systems (including components of individual operating units within the systems) may not be extensively described herein. Moreover, the connecting lines depicted in the figures throughout this document are intended to exemplify functional relationships and/or physical couplings between the various elements. It is important to note that a practical system may include many alternative or additional functional relationships or physical connections beyond those shown.

In various embodiments, the EAF marketplace comprises the user Interface, software modules, databases including blockchain database, network, and integration with external services and APIs to provide marketplace functionalities. While specific technologies, hardware, equipment, system architectures, and data management techniques are mentioned in the description, it should be understood that these references represent only one embodiment, and alternative devices and methods may be employed without deviating from the scope of the invention. Additionally, while the description mentions user interaction through a personal computer interface, it should be noted that other interfaces such as mobile devices, kiosks, and handheld devices like personal digital assistants can also be utilized.

“Investors” refers to individuals, organizations, or entities that provide capital or funding with the intention of generating a return on investment. In the marketplace, investors can explore various financial instruments and energy assets to allocate their funds. “Investment” represents the act of allocating capital or funds with the expectation of generating profit or income. In the marketplace, investors can make investments in energy assets through financial instruments. “Issuer” refers to individuals, organizations, or entities that own energy assets and raise funding for its development through tailormade financial instruments under certain terms and conditions. These issuers can be energy project developers, energy companies, commercial entities such as hotels, airlines, hospitals, malls, industries, or other entities seeking funding for their energy assets, e.g., rooftop solar. “Energy Assets” refers to tangible or intangible assets related to the energy sector, such as renewable energy projects, power plants, energy infrastructure, or energy-related technologies. These assets can be financed, traded, owned, or represented through financial instruments in the marketplace. “Diverse Financial Instruments” represents a range of financial products or securities available in the marketplace, including project bonds, green bonds, green loans, green funds, carbon offset finance, peer-to-peer lending, futures, structured finance products, project finance arrangements, asset-backed securities, revenue-sharing agreements, power purchase agreements, digital assets, tokens, and other innovative instruments tailored for energy finance.

“Tokens” are digital assets or units of value that can be created, purchased, and traded on the marketplace. These tokens may represent ownership rights, energy value, or other rights associated with energy assets or financial instruments. “Digital Assets” represent digital representations of physical or financial assets that can be stored, transferred, and traded electronically. In the marketplace, tokens and other digital representations enable the efficient exchange of value and ownership. “Purchase and Trade” refers to the actions of acquiring tokens, or financial instruments in the marketplace through financial transactions. Investors can purchase tokens or financial instruments and trade them with other participants in the marketplace. Fiat Currency” refers to traditional government-issued currencies, such as USD, EUR, or GBP, that are recognized as legal tender. In the marketplace, investors may use fiat currency for transactions and investments. “CBDC” represents digital currencies issued by central banks, while “cryptocurrencies” are decentralized digital currencies based on cryptographic technology. The marketplace may support transactions involving CBDCs and cryptocurrencies. “Proof of Transaction” represents evidence or confirmation of a completed transaction recorded on the database including blockchain. It provides a verifiable record of ownership, transfer, or participation in financial activities within the marketplace. “

These terms collectively shape the ecosystem and operations of the EAF marketplace, enabling investors to explore diverse financial instruments including tokens, buy and trade financial instruments, transact securely, and engage in energy asset financing within a technologically advanced and efficient environment.

FIG. 1 shows an embodiment of a high-level conceptual design for enabling an EAF marketplace. The system includes a user interface as the front end for external entities (e.g. users, issuers, investors, regulators, consultants etc.) to interact with the marketplace. Likewise, several processes and legacy and blockchain databases constitute the back end of the marketplace. The user interface facilitates a user-friendly environment that promotes a cohesive user experience, enabling convenient access to the marketplace's functionalities and fostering interaction with various system components. System management processes ensure effective and efficient management of the system, users, projects, financial instruments, and tokens. The marketplace processes facilitate seamless functioning, encompassing the creation and trading of financial instruments and tokens, investment activities, transaction processing, payment, and settlement procedures, as well as comprehensive reporting and analytics capabilities. Supporting processes are implemented to generate system and user value through profiling, personalization, user alerts and engagement, multicurrency payments, and other value-added services. These processes also aid in managing risk, regulatory and legal compliance, and security measures, thereby ensuring a secure and dependable marketplace environment. The data generated within the EAF marketplace is stored in both legacy and blockchain databases, leveraging the advantages offered by blockchain technology for digital assets and token creation, managed through the use of smart contracts.

Additionally, secondary technologies, such as marketplace API for third-party integration, artificial intelligence (AI), and machine learning (ML), support efficient and effective marketplace operations by analyzing marketplace behaviors, identifying patterns, making data-driven predictions and recommendations on demand, pricing, and sentiments, managing risk and compliance, and providing business analytics for in-depth analysis and forecasting. The analytics capabilities enable the system to generate valuable insights from the vast amount of data collected, empowering users to make informed investment decisions and driving continuous improvement within the marketplace. The payment and settlement processes accommodate various payment options, including fiat currency, central bank digital currency (CBDC), and digital currencies, ensuring seamless trade of financial instruments using any currency. The Application Programming Interface (API) integrates external connections to different systems, including legacy systems, communication, and network technologies, ensuring seamless connectivity and compatibility, thereby enabling applications to interact and exchange data efficiently and securely. In combination, these primary system components and secondary technologies synergistically collaborate to deliver a comprehensive and efficient EAF marketplace experience, meeting user demands while upholding compliance, security, and effective marketplace operations.

The EAF marketplace can be enabled through a standardized web server architecture. This architecture comprises a plurality of components, including a client, a web server, an application server, a database server, load balancers, caching servers, firewall and security components, an operating system, and a networking infrastructure. The web server receives and processes user requests through clients, while the application server handles dynamic content generation, and the database server manages data storage. In high-traffic, high-availability, or scalability environments, load balancers are employed to distribute client requests, thereby distributing the workload, and enhancing performance by preventing server overload. Additionally, caching servers are utilized to store frequently accessed resources, while security components safeguard against potential threats. The web server architecture relies on the operating system and networking infrastructure to establish connections and facilitate data transfer. By synergistically working together, these components effectively handle client requests, process logic, deliver content, and ensure the seamless operation of the EAF marketplace.

Participants in the online marketplace include both registered and non-registered users who actively engage with the EAF marketplace. These participants, such as investors, issuers, consultants, and service providers, interact with the platform through a user-friendly interface that facilitates their registration process, creation of user accounts, and seamless navigation within the marketplace. In some embodiments, the interface is intuitively designed to enable the effortless discovery of products, execution of transactions, and generation of comprehensive reports. By leveraging these capabilities, participants can fully exploit the marketplace's potential, enhancing their overall engagement and satisfaction.

In certain embodiments, the user experience within the system is improved through the utilization of profiling tools, behavior analysis techniques, and personalized content delivery mechanisms. Profiling tools are employed to gather and analyze user data, enabling the system to generate user profiles based on various attributes and preferences. Behavior analysis techniques are utilized to analyze user interactions, patterns, and preferences, thereby facilitating the understanding of user behavior within the system. Furthermore, personalized content delivery mechanisms are implemented to provide tailored content and recommendations to users based on their individual profiles and behavior patterns.

FIG. 3 illustrates a schematic representation of the Listing Database within the EAF Marketplace, specifically designed for the funding process involving FIs for energy assets. The FIs of qualified assets from a due diligence procedure are listed to secure funding from potential investors in the marketplace. In certain embodiments, this listing is presented in a structured tabular format for enhanced user comprehension. The data fields encompass essential information, including the name of the issuer or company owning the energy asset seeking funding, along with the country of registration. Additionally, it includes the name of the specific energy project or asset in need of funding. Moreover, a Riskometer assigns a risk rating from 1 to 10, where 1 indicates the lowest risk, and 10 denotes the highest, providing investors with an assessment of the asset's risk level. Likewise, a Greenometer assigns a green rating from 1 to 10, with 1 being the least environmentally friendly and 10 representing the highest green rating, facilitating investors' understanding of the asset's environmental impact. Both the Riskometer and Greenometer values are derived as part of the asset's due diligence process for funding. The type of energy asset is also indicated, specifying the underlying technology employed, such as solar, wind, hydro, oil, natural gas, etc. Other critical details listed include the total capacity and cost of the asset, denoted in the specified currency. To accommodate the global nature of the marketplace, the currency field allows for flexibility in expressing financial values in different currencies. The total EAF funding represents the approved value for raising funds within the marketplace, which may be obtained from one or multiple FIs. The breakdown of FIs illustrates the total value being raised by a particular type of FI, the unit price of each FI, and the total number of issued FIs contributing to the funding process. To adapt to the dynamic nature of the marketplace, the remaining FIs for sale is regularly updated with each FI purchase to indicate the funding raised so far and the remaining investment opportunities. Additionally, the listing date and closing date are specified to keep market participants informed about the FI's listing date and the deadline for purchase, subject to FI availability.

The EAF marketplace is inherently designed to integrate the Assessment of the asset for suitability of funding as a fundamental and integral component of the overall funding process. The funding process for an energy asset within the marketplace comprises a series of steps, as depicted in FIG. 2. This encompasses feasibility assessment, creation of a financing plan for feasible assets, generation and listing of Financial Instruments (FIs), and subsequently, their acquisition by investors. The energy asset holder seeking funding registers as an issuer and provides relevant asset details along with supporting documents. A thorough evaluation of the asset, referred to as Due Diligence, is carried out through a combination of human and marketplace intervention to assess the feasibility of the asset for financing. For assets found feasible on the marketplace, an appropriate financing plan is formulated, incorporating Riskometer and Greenometer ratings. The financing plan includes critical components, such as funding class (e.g., debt, equity, mezzanine), total funding amount for each funding class, specific funding terms for each class, total number of FIs and their corresponding unit prices for the respective funding of each class. Subsequently, these FIs are created and listed within the marketplace, as illustrated in FIG. 3, for sale.

Each individual unit of the FI contains crucial information, such as a unique identifier, issuer and project details, FI creation and validity dates, and relevant financing terms and conditions. It is essential to note that each FI serves as a contract between the issuer and the investor purchasing the asset, outlining the terms and conditions of the investment and defining the rights and obligations of both parties. This contractual agreement explicitly states the investor's entitlement to the benefits and returns linked to the underlying FI and specifies the issuer's responsibilities in managing the FI and delivering the agreed-upon returns. As a legally binding document, the FI plays a pivotal role in governing the relationship between the investor and the issuer for the entire investment duration.

A sample FI issued by an issuer is illustrated in FIG. 5. The FIs are created as digital assets on the blockchain with specific ownership details and immutable terms of financing enclosed within. The use of blockchain ensures transparency, security, and traceability of ownership and financing terms throughout the lifecycle of the FIs within the marketplace.

Listing the FI for sale in the EAF marketplace means that it is offered to potential buyers who may be interested in acquiring it. On the other hand, if an investor wants to sell their FI, they can make it available for purchase by others, and this is referred to as a “trading” or “sell order.” The EAF marketplace facilitates the matching of buyers and sellers, allowing for the trading and transfer of FIs between different parties.

Qualified investors acquire FIs to achieve diverse goals, including financial returns, tax benefits, market opportunities, environmental impact, social considerations, and ESG integration while supporting asset development. The process involves selecting an energy asset and corresponding FI from the Listing Database and specifying the desired quantity for purchase. The system computes the total investment and guides the investor to the payment page. After successful payment, FIs are transferred to the investor, and the transaction, along with the new ownership details, is recorded on the blockchain.

In some embodiments, the EAF marketplace facilitates the acquisition of FIs through a diverse array of payment options, comprising Fiat currency, Central Bank Digital Currency (CBDC), and digital currencies such as cryptocurrencies, as depicted in FIG. 8. This comprehensive range of payment methods serves to not only broaden the accessibility of funding for energy assets but also to enhance transactional flexibility for users. Moreover, the marketplace is thoughtfully designed to efficiently manage automatic conversions of foreign Fiat currency and CBDC into the native currency through a dedicated currency exchange. Similarly, in the case of digital currencies, users have the option to either convert them into Fiat currency via a crypto exchange or to leverage their digital assets by depositing them into a crypto-backed lending platform to borrow Fiat currency. The ability to purchase an FI using any currency preferred by the investor is indeed advantageous, providing investors with a sense of autonomy and enlarging the financing scope for global energy assets by incorporating CBDCs and Digital Currencies, hitherto untapped in the realm of real-world investments.

Within the EAF marketplace, every transaction involving the purchase of FIs is meticulously captured and recorded to maintain an accurate and comprehensive record of ownership and investment activities. This information is stored in a dedicated Trading Database, as depicted in FIG. 4. This database operates as a chronological ledger, meticulously capturing a comprehensive history of all transactions conducted within the marketplace. To ensure the privacy and security of the investor, sensitive investor details are omitted from the publicly accessible ledger. A BUY transaction is executed when an investor purchases an FI available for sale from the issuer at the original Issuance Price. In contrast, a TRADE transaction is conducted when an investor sells their FI, and the Offered Price may deviate from the Issuance Price based on demand, supply, and marketplace suggestions. The total transaction value is calculated, and the purchase is duly recorded along with the transaction date. The completion of the process occurs following successful payment, settlement, and the blockchain-based transfer of FI ownership to the acquiring investor. The schematic representation of the TRADE transaction process is depicted in FIG. 6, providing further clarity on the sequence of events.

In some embodiments, the EAF marketplace facilitates the green certification of investors by collecting information about their investment portfolios in clean energy and Net Zero assets. It analyzes portfolios to assess the level of green investment according to predefined criteria and standards. The marketplace issues green investment ratings and generates certificates through the platform. These ratings and certificates serve as evidence of an investor's investment in clean energy and Net Zero assets as well as the commitment to sustainability and responsible investment practices. The marketplace regularly updates the green certification rating based on changes in the investor's portfolio, ensuring a continuous evaluation and certification of their sustainability efforts.

The EAF marketplace fundamentally incorporates the Tokenization of Energy Assets as a core feature. Tokenization of Energy Assets offers an innovative and efficient mechanism for raising equity funding within the marketplace while ensuring compliance with relevant regulatory requirements. In this process, energy assets are digitally represented as tokens on a blockchain network, thereby creating fractional ownership opportunities for potential investors. The tokenization process empowers energy asset owners to divide their assets into smaller tradable units, facilitating the sale of these tokens in the marketplace to secure equity capital. Correspondingly, investors can participate by acquiring these tokens, thereby obtaining fractional ownership in the underlying energy asset. This approach fosters greater access to investment opportunities, as investors with varying capital can engage in the marketplace. Moreover, the secondary market trading of these tokens within the marketplace enhances liquidity, enabling investors to exit their positions when required. The tokenization of energy assets thus opens up promising prospects for asset owners and investors to actively engage in the energy sector while fostering sustainable growth. The process of tokenization of energy assets and the subsequent trading of resulting tokens within the marketplace is visually depicted in FIG. 7. For energy assets seeking funding through tokenization, tokens are generated based on the financing plan for assets found feasible for funding following asset evaluation or due diligence. These tokens are listed for sale in the marketplace, where investors purchase them to provide funding for the asset's development. The token purchase transaction is completed once successful payment and settlement occur, leading to the transfer of tokens to the issuer and the recording of the transaction in the Trading database.

In some embodiments, the EAF marketplace consists of a number of back-end processes as illustrated in FIG. 1. The management processes within the marketplace encompass system management, account management, project management, FI management, and tokenization. The system management process ensures the efficient functioning and maintenance of the marketplace, including server monitoring, load balancing, data security, software updates, and database administration. Account management focuses on user account creation and maintenance, handling tasks such as registration, verification, password management, and user support. Project management oversees the creation and management of projects, including processing and maintaining data related to project due diligence, financing plans, and trading activities. The FI management process enables the creation and issuance of diverse FIs according to the financing plan, while the tokenization process converts energy assets into digital tokens on a blockchain network, allowing fractional ownership and compliance with regulations. Collectively, these management processes contribute to the smooth operation of the marketplace and ensure a seamless user experience.

The EAF marketplace encompasses essential processes that enable efficient listing, sale, and trading of FIs and Tokens. It facilitates secure payment and settlement procedures, seamless transaction processing, and comprehensive reporting to ensure transparency and accountability. These processes work together to create a robust and user-friendly platform for investors and issuers, facilitating the exchange and management of FIs within the marketplace.

Supporting processes, including profiling, investor and issuer engagement, alert and messaging services, value-added services, and currency exchange, play a crucial role in enhancing the functionality and user experience of the EAF Marketplace. Profiling capture user preferences ad behavior, investment profiles, and risk appetite, allowing for personalized recommendations and targeted offerings tailored to the specific interests, preference and objectives of individual users. Investor and issuer engagement activities foster a strong and interactive community within the marketplace, encouraging active participation and collaboration. Alert and messaging services keep users informed about important updates, new investment opportunities, market trends and relevant news. Users can customize their notification preferences and receive real-time alerts via email, SMS, or in-app notifications. The messaging system allows seamless communication between users, facilitating collaboration and negotiation during investment processes. Value-added services offer additional benefits and features to users, such as expert insights, analytics, and risk assessments, providing a competitive advantage and attracting a broader user base. Currency exchange functionality enables seamless conversion of various currencies, accommodating international investors and expanding the reach of the EAF Marketplace. This flexibility allows investors and project developers to transact in their preferred currency and leverage the benefits of digital currencies, such as faster settlement and lower transaction costs. Together, these supporting processes contribute to the Marketplace's efficiency, user satisfaction, and overall success, creating a thriving ecosystem for energy asset financing and investment.

Lastly, processes related to risk management, legal and regulatory compliance, and security play a pivotal role in ensuring the marketplace's stability, trustworthiness, and adherence to industry standards. Risk management processes assess and mitigate potential risks associated with investment activities and financial transactions, safeguarding investors and asset owners from potential losses. Legal and regulatory compliance processes ensure that all marketplace activities are conducted in accordance with relevant laws, regulations, and licensing requirements, fostering a transparent and compliant environment. This helps build trust among users and stakeholders while mitigating legal risks for the marketplace operator and participants. Security processes focus on safeguarding sensitive data, preventing unauthorized access, and protecting against cyber threats. These measures include encryption, authentication, access controls, and regular security audits, creating a secure platform for users to conduct their financial activities with confidence. Overall, these processes collectively contribute to the Marketplace's robustness, credibility, and resilience, fostering a safe and trustworthy environment for energy asset financing, investment, and trading.

Additionally, in certain embodiments, the EAF Marketplace is equipped with several advanced system components that are strategically incorporated to significantly enhance functionality and optimize the overall user experience. These components leverage the latest advancements in machine learning, artificial intelligence (AI), and business analytics to deliver a wide array of advanced features and functionalities that cater to the diverse needs and preferences of users. The system utilizes machine learning algorithms and AI techniques to analyze large datasets, identify patterns, and generate insights. This enables personalized investment recommendations, risk assessments, and predictive analytics for investors and project developers. It also facilitates intelligent matching of investors with suitable energy projects based on their preferences and investment criteria. The system employs sophisticated business analytics tools to analyze market trends, investment performance, and risk profiles. It provides comprehensive visualizations and reports to help users make data-driven decisions, optimize investment strategies, and identify emerging opportunities in the energy finance market. These advanced system components significantly enhance the functionality and user experience within the EAF marketplace.

To summarize, the disclosures of the Invention are:

A primary object of the present invention is to establish a novel system and method for financing global energy assets through a marketplace of diverse financial instruments. By connecting global investors with energy asset owners needing funding, the innovation helps to expand funding opportunities. By enabling actual funding, the innovation bridges the investment and gap, expedites investments in energy development, contributing to energy resilience, energy security, clean energy, and Net Zero goals.

Another object of the present invention is to demonstrate how to create and operate a marketplace of diverse and tailor-made financial instruments that broadens the financing opportunities of global energy assets, fosters private sector participation in global energy funding, and bridges the energy investment gap worldwide.

Another object of the present invention is to demonstrate how to increase private sector investment in the financing of global energy assets through a digital platform that enhances the accessibility of global institutional and private investors to unlock funding for energy asset developers.

Another object is to showcase the process of onboarding global energy asset owners in need of funding, registering energy assets, conducting eligibility for funding, establishing funding criteria, creating financial instruments as per the criteria, offering the financial instruments for sale in the marketplace, facilitating the discovery and connection with interested and capable investors, executing and recording the purchase of financial instruments, completing payment and settlement transactions, and enabling the trade of financial instruments for liquidity requirements of the investor.

Another object is to provide such a system to accelerate global progress in clean energy and Net Zero projects by utilizing financial instruments that are tailored to leverage commitments, incentives, policies, goals, and mandates of countries, institutions, and individuals, thus enabling the achievement of clean energy objectives while providing attractive financial returns.

Another object of the present invention is to provide a system to revolutionize energy asset financing and energy security by introducing tokens as specialized financial instruments that represent some intrinsic energy value, offer ownership rights to that energy, can be purchased and traded on the marketplace. Their value further remains monetized in the marketplace through a standardized correlation and/or demand-supply. Token ownership not only signifies an investment in energy but also grants rights to redeem the associated energy based on predetermined terms. This innovative approach not only facilitates new financing and investment opportunities but also opens new avenues for climate financing, and carbon offsets, and enhances energy security for token holders.

Another object of the invention is to showcase the utility and potential of its native token which has utilities in facilitating transactions, incentivizing participation, and promoting the growth of the marketplace. By demonstrating the value and functionality of the native token and maintaining a thriving token economy, the invention aims to establish a robust marketplace attracting a wider user base and fostering long-term engagement. Additionally, the invention seeks to demonstrate innovative use cases and applications for the native token in energy financing.

The invention aims to highlight the versatility and potential of its native token, which serves as a valuable tool for facilitating transactions, incentivizing participation, and driving the growth of the marketplace. By showcasing the value and practicality of the native token and cultivating a thriving token economy, the goal is to establish a resilient marketplace that attracts a broader user base and encourages sustained involvement. Moreover, the invention endeavors to illustrate innovative applications and use cases for the native token in the realm of energy financing.

Another object of the present invention is to utilize blockchain technology to create, record, and manage financial instruments as digital assets, enabling seamless ownership association and tracking, and ensuring transparency and auditing capabilities.

Yet another object of the present invention is to facilitate, record and maintain clean energy investments that can be used as carbon offsets.

Another object is to establish dedicated investment funds that allow investors to purchase financial instruments issued by the fund, enabling streamlined investment and participation in the global development of energy assets.

Another object is to facilitate global investment in energy assets using payment methods that involve multiple currencies and cross-border investments within a regulatory-compliant environment.

Another object of the present invention is to enhance investor convenience by providing a wide range of payment options, including various fiat currencies, CBDCs, and cryptocurrencies, thereby broadening the scope of financing and investment opportunities and increasing accessibility to funding.

Another object is to facilitate green rating and certification of investors by receiving information on their investment portfolios in clean energy and Net Zero assets.

Another object is to demonstrate how to attract and build a large pool of global investors and drive increased investment in clean energy projects.

Yet another object of the present invention is to introduce investment opportunities that cater to both long-term strategies and short-term trading, allowing investors to capitalize on the potential for long-term growth while also providing the flexibility to generate liquidity through short-term trading activities.

Another object of the present invention is to provide risk-assessed, mitigated and managed investment opportunities in global energy assets.

Another object is to facilitate convenient trading of financial instruments with low transaction costs.

Another object of the platform is to foster seamless interactions among participants, guaranteeing transparency, reliability, and efficiency at every stage of the financing process.

Another object of the present invention is to introduce innovative hedging strategies that mitigate risks associated with traditional equities and debt investments, such as currency fluctuations, ultimately reducing the cost of capital for investors.

Another object of the present invention is to offer an unbiased evaluation of the overall value generated by the investment, providing stakeholders with an objective assessment.

Another object of the present invention is to predict and forecast the future value of energy assets, funding, and investment, enabling informed decision-making and strategic planning.

Another object of the present invention is to facilitate efficient long-term investment in targeted value prospects, ensuring optimal utilization of resources and maximizing returns.

Another object of the present invention is to enable investment based on fair, realistic, and auditable performance metrics, ensuring transparency and accountability in the investment process.

Another object is to generate commercially valuable valuations of financial instruments by assessing their investment value, providing valuable insights for market participants.

An additional object is to empower investors to build portfolios by combining long and short positions of various financial instruments, enhancing flexibility and diversification in their investment strategies.

Another object of the invention is to foster active participation and encourage sustainable practices within the marketplace ecosystem by incentivizing market participants with additional tokens based on predefined criteria that align with the goals of the invention. By rewarding users for their engagement, contributions, and adherence to sustainable practices, the invention aims to create a dynamic and thriving marketplace where participants are motivated to actively participate and contribute to the overall growth and success of the ecosystem. This incentivization mechanism also helps to cultivate a community that values sustainability and collectively works towards achieving long-term environmental and social goals.

1. A computer-implemented method for facilitating the financing of diverse global energy assets, including but not limited to renewable energy, clean energy, net-zero, climate and sustainability-related, and carbon assets, comprising: a digital marketplace of diverse financial instruments (FIs) tied to energy assets, and involving a plurality of participants including investors, energy asset owners, issuers, and the energy assets themselves.

2. The marketplace of claim 1, wherein the FIs comprise of instruments that possess intrinsic financial value or represent units of energy that are also redeemable.

3. The marketplace of claim 1, wherein the FIs comprise of, but not limited to, equity securities, debt securities such as project bonds, green loans, green funds, carbon offset finance, peer-to-peer lending, renewable energy certificates, and promissory notes, tokens, digital assets, and other innovative instruments, are tied to energy assets and can be sold or traded in the marketplace to generate funding for the development of the energy asset.

4. Providing and receiving, via the said marketplace of claim 1, information related to a plurality of FIs, energy assets, investors, energy asset owners, and financial transactions.

5. Enabling said plurality of energy asset owners to access said marketplace of claim 1, to submit funding requests to develop their energy assets, and to receive funding by issuing diverse FIs for sale or trade.

6. The method of claim 1, further comprising the set of processes to assess global energy projects for their suitability of funding on the marketplace, creating a financial plan for suitable projects, creating FIs to support the financial plan, placing FIs on the marketplace for sale, execute purchase transactions of FIs including payment and settlement, and transfer their ownership to the buyer.

7. Enabling said plurality of investors to access said marketplace of claim 1, and express interest in acquiring or investing in one or more FIs of energy assets.

8. Executing financial transactions for the purchase or investment of said FIs on said marketplace of claim 1 by investors, using one or more of fiat currency, central bank digital currency (CBDC), or cryptocurrencies to provide funding to asset owners for the development of assets.

9. The method of claim 1, further comprising the set of processes to execute the payment process related to the purchase or trade of said FIs using one or more fiat currency, CBDC, or cryptocurrencies.

10. Facilitating the matching of investors and issuers of said FIs on said marketplace of claim 1, based on predetermined criteria and preferences.

11. The method of claim 1, further comprising analyzing investment portfolio data to determine the level of green certification for investors of the said marketplace based on predefined criteria and standards for clean energy and Net Zero investments.

12. The method of claim 1, further comprising facilitating green certification of investors by receiving investment portfolio information, analyzing portfolios, generating green investment rating certifications, and updating ratings based on portfolio changes.

13. The method of claim 1, further comprising tokenizing energy assets using a blockchain platform to generate unique digital tokens representing value, ownership, or investment rights in energy assets that are tradable on the said marketplace platform or intermediaries.

14. The method of claim 1, further comprising creating tokenized energy-backed digital assets capable of being bought, transferred, traded, or redeemed for energy utilization.

15. The method of claim 1, further comprising managing token ownership, monitoring tokenized energy asset performance, distributing rewards, and ensuring regulatory compliance related to tokenized energy assets.
